(19) United States
(12) Patent Application Publication
(10) Pub. No.: US 2026/0065590 A1
(43) Pub. Date: Mar. 5, 2026

(54) VISUALIZATION OF NON-COMPOSITE OBLIQUE IMAGERY SCENE VIEWS USING THREE-DIMENSIONAL MODEL DATA FOR MANIPULATION OF ANNOTATION FEATURE OVERLAYS

(71) Applicant: FNV IP B.V., Leidschendam (NL)

(72) Inventors: Justin RICHWAGEN, Frederick, MD (US); Guy MEIRON, Boonsboro, MD (US); Azhar IBRAHIM, Brunswick, MD (US); Michael WERNAU, Leisburg, VA (US)

(21) Appl. No.: 18/824,862

(22) Filed: Sep. 4, 2024

(51) Int. Cl. G06T 17/05; G06V 20/10; G06V 20/70

(52) U.S. Cl. CPC G06T 17/05; G06V 20/10; G06V 20/70

(57) ABSTRACT

Described are systems and techniques for visualization and manipulation of non-composite oblique aerial imagery. Information can be obtained for an annotation feature for overlay on a displayed oblique image with an oblique viewpoint of a scene within a geographic area. Three-dimensional (3D) model data can be obtained for a portion of the geographic area and including 3D information of object surfaces within the scene. A 3D representation of the annotation feature can be generated using the 3D model data and georeferenced coordinates determined for the annotation feature. An oblique projection of the 3D representation of the annotation feature into the oblique viewpoint of the scene can be generated to include portions of the annotation feature unobstructed by the object surfaces within the scene. The oblique projection of the annotation feature can be output as a two-dimensional (2D) overlay on the displayed oblique image.

### FIELD

Aspects of the present disclosure generally relate to the visualization and rendering of map data, including oblique imagery and/or other aerial imagery. For example, aspects of the present disclosure are related to visualization of non-composite oblique aerial imagery using three-dimensional model data for the projection and reprojection of annotation feature overlays across different oblique imagery orientations of an area of interest.

### BACKGROUND

Geographic information system (GIS) and other map and/or imagery data visualization systems often utilize orthogonal or top-down aerial imagery to provide a more detailed view of a geographic area or geographic scene of interest. Orthogonal images may also be referred to as “ortho” images or “orthoimagery”, and can be captured using a camera positioned at some height above the ground surface and oriented at an approximately orthogonal angle (e.g., perpendicular) to the ground surface or ground reference plane. Orthogonal images can be captured by cameras mounted to an airborne vehicle such as a plane, helicopter, drone, UAV, etc., as the airborne vehicle is flown in a pattern over a geographic area or region that is to be mapped by the resulting orthogonal imagery data. In another example, orthogonal images can be captured by satellites having one or more cameras with imaging axes oriented orthogonal to the ground surface or ground reference plane. Orthogonal aerial imagery may be adjusted for topographic features or topographic relief, lens distortion, atmospheric distortion, etc., and is often used in mapping and visualization applications as a baseline representation to provide accurate and uniform scaling across different geographic scenes or views.

Orthogonal aerial imagery can be considered a first type of aerial imagery, associated with capturing top-down views at an angle of approximately 90° between the imaging axis of the camera and the surface of the ground. Oblique aerial imagery is another type of aerial imagery, associated with capturing side-angle views at angles less than 90° between the imaging axis of the camera and the surface of the ground. For example, oblique aerial images may be taken at angles of 40° to 60° from relatively low-flying aircraft, as well as from various other non-orthogonal angles with respect to the ground surface or ground reference plane. The side-angle perspective provided by oblique images can allow the sides of buildings, structures, and terrain features to be seen, and may additionally provide a more natural perspective to the human eye. Oblique images can be captured from various different tilt angles (e.g., the angle between the camera imaging axis and the ground) and/or from different orientations. In some examples, oblique imagery can be captured using camera systems that are configured to simultaneously capture multiple oblique images in multiple different directions or orientations in the horizontal plane. For example, an oblique imaging system may use four separate cameras or imaging sensors to perform simultaneous capture of respective oblique images in each of the four cardinal directions (a first camera captures oblique images from a north-facing orientation, a second camera captures oblique images from an east-facing orientation, a third camera captures oblique images from a south-facing orientation, and a fourth camera captures oblique images from a west-facing orientation).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In one illustrative example, a method of oblique imagery visualization can include: obtaining information corresponding to an annotation feature for overlay on a displayed oblique image (e.g., an oblique image that is being output and/or rendered for display or other presentation to a user), wherein the displayed oblique image is included in a plurality of oblique aerial images of a geographic area, and wherein the displayed oblique image is an oblique viewpoint of a scene within the geographic area; obtaining three-dimensional (3D) model data corresponding to at least a portion of the geographic area, wherein the 3D model data includes 3D information of object surfaces within the scene; generating a 3D representation of the annotation feature based on the 3D model data and one or more georeferenced coordinates determined for the annotation feature; obtaining an oblique projection of the 3D representation of the annotation feature into the oblique viewpoint of the scene associated with the displayed oblique image, wherein the oblique projection includes one or more portions of the annotation feature that are unobstructed by the object surfaces within the scene; and outputting the oblique projection of the 3D representation of the annotation feature as a two-dimensional (2D) overlay on the displayed oblique image.

In some aspects, the method can further include obtaining a user input indicative of an updated oblique viewpoint of the scene, wherein the updated oblique viewpoint corresponds to a second oblique image different from the displayed oblique image; and generating an updated oblique projection of the 3D representation of the annotation feature for the updated oblique viewpoint of the scene.

In some aspects, the method can further include outputting the second oblique image and the updated oblique projection of the 3D representation of the annotation feature as a 2D overlay on the second oblique image.

In some aspects, generating the updated oblique projection comprises reprojecting the 3D representation of the annotation feature from a 3D space of the 3D model data to a 2D oblique space corresponding to the updated oblique viewpoint of the scene.

In some aspects, the oblique viewpoint of the scene is based on an image frame center coordinate of the displayed oblique image and a georeferenced boundary information associated with one or more of the displayed oblique image or the scene within the geographic area.

In some aspects, the oblique viewpoint of the scene is based on an orientation angle or heading information of the displayed oblique image.

In some aspects, the one or more portions of the annotation feature that are unobstructed by the object surfaces are determined based on intersecting the 3D representation of the annotation feature with the 3D information of the object surfaces within the scene.

In some aspects, the one or more portions of the annotation feature that are unobstructed by the object surfaces are further determined based on parameterizing a 3D to 2D projection of the 3D representation of the annotation feature based on orientation angle or heading information included in the oblique viewpoint of the scene.

In some aspects, the oblique projection does not include one or more portions of the annotation feature that are obstructed by the object surfaces within the scene.

In some aspects, the 3D representation of the annotation feature is generated in a same 3D coordinate system as the 3D model data, based on transforming the one or more georeferenced coordinates to the 3D coordinate system.

In some aspects, the oblique projection comprises a 3D-to-2D projection.

In some aspects, the 3D model data comprises Digital Surface Model (DSM) 3D data corresponding to one or more objects or elements included within the scene within the geographic area.

In some aspects, the 3D model data includes supplemental 3D information indicative of one or more surfaces and corresponding georeferenced coordinates of one or more objects or elements included within the scene within the geographic area.

In some aspects, the annotation feature comprises at least one of an annotation point, a line, a polyline, text data, a polygon, or an enclosed area within the scene.

In another illustrative example, an apparatus is provided. The apparatus includes at least one memory and at least one processor coupled to the at least one memory and configured to: obtain information corresponding to an annotation feature for overlay on a displayed oblique image, wherein the displayed oblique image is included in a plurality of oblique aerial images of a geographic area, and wherein the displayed oblique image is an oblique viewpoint of a scene within the geographic area; obtain three-dimensional (3D) model data corresponding to at least a portion of the geographic area, wherein the 3D model data includes 3D information of object surfaces within the scene; generate a 3D representation of the annotation feature based on the 3D model data and one or more georeferenced coordinates determined for the annotation feature; obtain an oblique projection of the 3D representation of the annotation feature into the oblique viewpoint of the scene associated with the displayed oblique image, wherein the oblique projection includes one or more portions of the annotation feature that are unobstructed by the object surfaces within the scene; and output the oblique projection of the 3D representation of the annotation feature as a two-dimensional (2D) overlay on the displayed oblique image.

In another illustrative example, a non-transitory computer-readable storage medium comprising instructions stored thereon which, when executed by at least one processor, causes the at least one processor to: obtain information corresponding to an annotation feature for overlay on a displayed oblique image, wherein the displayed oblique image is included in a plurality of oblique aerial images of a geographic area, and wherein the displayed oblique image is an oblique viewpoint of a scene within the geographic area; obtain three-dimensional (3D) model data corresponding to at least a portion of the geographic area of interest, wherein the 3D model data includes 3D information of object surfaces within the scene; generate a 3D representation of the annotation feature based on the 3D model data and one or more georeferenced coordinates determined for the annotation feature; obtain an oblique projection of the 3D representation of the annotation feature into the oblique viewpoint of the scene associated with the displayed oblique image, wherein the oblique projection includes one or more portions of the annotation feature that are unobstructed by the object surfaces within the scene; and output the oblique projection of the 3D representation of the annotation feature as a two-dimensional (2D) overlay on the displayed oblique image.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 is a diagram illustrating an example of geographic scene visualization based on stitching or compositing of a plurality of images into a composite image, in accordance with some examples;

FIG. 2 is a diagram illustrating an example of geographic scene visualization using configured or requested view perspective information to determine a matching non-composite image, in accordance with some examples;

FIG. 3 is a diagram illustrating an example of an oblique imagery visualization system configured to use view perspective information and a corresponding view-based query for generating a rendered output view of a selected non-composite oblique image, in accordance with some examples;

FIG. 4 is a diagram illustrating an example of a panning operation corresponding to first and second view frames of a geographic scene visualization, wherein the first and second view frames are based on separate and non-composite oblique images, in accordance with some examples;

FIG. 5 is a diagram illustrating an example of a rotation operation corresponding to first and second view frames of a geographic scene visualization, wherein the first and second view frames are based on separate and non-composite oblique images, in accordance with some examples;

FIG. 6A is a diagram illustrating an example of a first oblique image view of a scene with an annotation feature overlay comprising a distance measurement line, in accordance with some examples;

FIG. 6B is a diagram illustrating an example of a second oblique image view corresponding to a 180-degree orientation rotation from the first oblique image view of FIG. 6A, with the same annotation feature overlay included, in accordance with some examples;

FIG. 6C is a diagram illustrating an example of the second oblique image view of FIG. 6B, with the annotation feature overlay of the distance measurement line rendered based on three-dimensional (3D) perspective and obstruction information corresponding to the oblique image view scene, in accordance with some examples;

FIG. 7 is a diagram illustrating an example of an oblique image view of a scene with an annotation feature overlay comprising a distance measurement line rendered based on using 3D perspective and obstruction information of the scene to determine obstructed and non-obstructed portions of the distance measurement line, in accordance with some examples;

FIG. 8 is a flow diagram illustrating an example of a process for non-composite oblique imagery visualization and/or manipulation, in accordance with some examples; and

FIG. 9 is a block diagram illustrating an example of a computing system for implementing certain embodiments of the present technology, according to embodiments of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

As noted previously, aerial imagery data and/or aerial mapping data (including GIS data, etc.) can be divided into orthogonal images, captured at an approximately 90° angle between the camera and the ground, and oblique images, capture at angles of less than 90° between the camera and the ground. Orthogonal images provide a top-down perspective that can be geometrically corrected to achieve a uniform scale and minimize perspective distortions across the individual images of a set of multiple different orthogonal images. For example, the 90° angle between the camera and the ground that is used when capturing orthogonal images can result in an approximately constant scale across the pixels of a single orthogonal image (e.g., same distance per pixel for each pixel of an orthogonal image) and an approximately constant scale between multiple orthogonal images (e.g., same distance per pixel for the pixels included in each different orthogonal image).

The consistent top-down perspective and pixel scale associated with orthogonal aerial imagery can be leveraged to perform image stitching or tiling to align the borders of the separate orthogonal images captured for adjacent geographic areas, to thereby generate a seamless and continuous composite image for a larger geographic area or region that is mapped in a dataset comprising a plurality of orthogonal images. For example, image stitching for orthogonal images can be performed based on acquiring multiple overlapping images in both the forward and lateral directions, and using computer vision or other feature recognition and/or feature matching techniques to align adjacent images based on distinct features found in the overlapping portions of adjacent orthogonal images. The features used for stitching orthogonal images into a larger, singular composite image can include geographic or terrain features (e.g., objects that are depicted in the images themselves), and/or can include properties and characteristics of the image such as corners, edges, unique patterns, etc. Based on identifying the same feature in an overlapping portion between adjacent orthogonal images, relative positioning and orientation information (and in some cases, scaling information) can be calculated to transform and align the separate orthogonal images for stitching into what appears to the viewer as a single continuous or seamless image spanning the field of view of the combined orthogonal images as a whole.

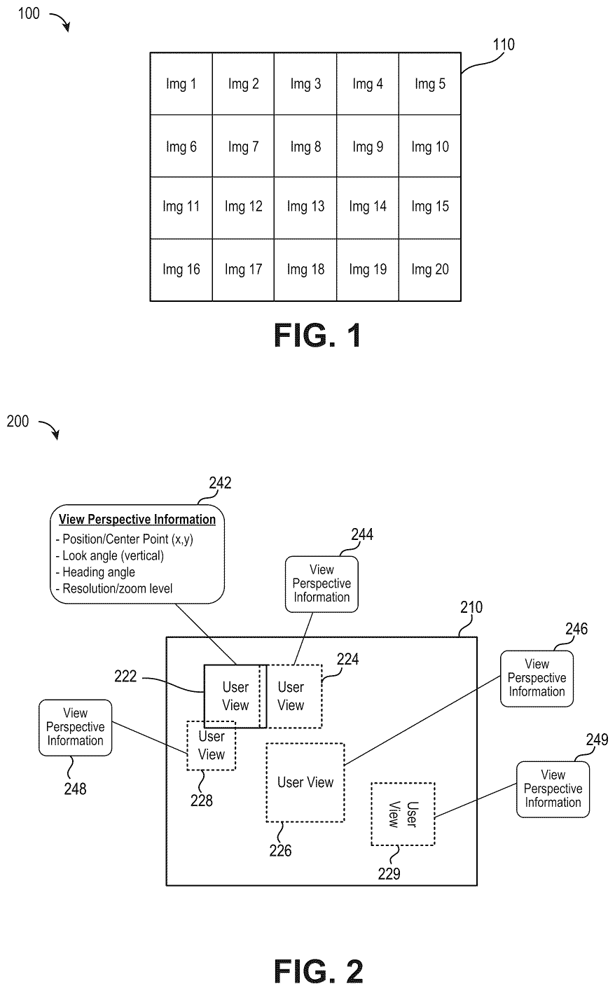

For example, FIG. 1 is a diagram illustrating an example of geographic scene visualization 100 based on stitching or compositing of a plurality of images into a composite image 110, in accordance with some examples. For instance, FIG. 1 provides a schematic representation of a composite image 110 that can be generated based on stitching, combining, blending, mosaicking, tiling, etc., a plurality of separate images (e.g., Img 1, Img 2, . . . , Img 20, etc.) to be aligned with one another. The plurality of separate images can be orthogonal images that are at least partially overlapping with one or more adjacent images, with the overlap used to perform the feature matching and alignment as described above. Stitching the plurality of separate images into the singular, composite image 110 allows users (e.g., users of a geographic scene viewer that provides visualization, interaction, and/or manipulation of the composite image 110) to pan, scroll, and/or rotate to different viewpoints within the composite image 110 without noticing sudden or abrupt transitions when changing the view frame from an area that was captured in the image data of a first image (e.g., Img 1) to an area that was captured in the image data of a different/second image (e.g., Img 2, Img 6, etc.).

Geographic viewer functionality that is implemented for composite images or other stitched sets of aerial imagery may be based on rendering a requested viewpoint or view frame directly from underlying data (or data object(s)) generated and stored for the singular, composite image itself. In other words, geographic viewers that display view frames of a composite image previously generated from performing image stitching for a plurality of separately captured images do not access or render the output from the respective data of each separately captured image, and instead access and render the output based on using a corresponding subset of the data that was generated for the single composite image.

Performing the image stitching operations to generate the singular, composite image from a plurality of separately captured images (e.g., such as a plurality of aerial orthogonal images captured at various areas or locations within the larger geographic area or region that is to be represented in the composite image 110) can be computationally complex, time-consuming, and cumbersome. It would be desirable to provide systems and techniques that can provide geographic scene views and manipulations of the configured viewpoint or view perspective without the need to previously generate, store, and then access a calculated composite image.

Image stitching may additionally be challenging or impossible to perform for oblique aerial imagery and oblique imagery datasets, for instance based on the scale variations and distortions and/or perspective changes that are present across different oblique image views. For example, unlike orthogonal imagery which is captured from a consistent top-down perspective and may be geometrically corrected to a uniform scale, oblique images can include perspective distortions and scale variations. In oblique images, objects in the captured image can vary in their distance from the camera or imaging sensor, which can cause perspective and scale distortions.

In orthogonal images, objects in the captured image are all approximately the same distance from the camera (disregarding vertical height differences of objects perpendicular to the ground, as such height differences are effectively compressed in orthogonal images based on the imaging axis also being perpendicular to the ground). However, in oblique imagery, the tilt angle of the camera used to capture the image (e.g., the angle between the camera and the ground, where the angle is less than 90°) causes the objects in frame to vary in their distance from the camera. For example, the objects in the lower half of an oblique aerial image are typically closer to the camera than the objects in the upper half of the oblique aerial image. Based on the varying distance to the camera for objects within the same oblique image, the objects closer to the camera will appear larger than more distant objects, and the scale (e.g., distance or length per pixel, etc.) within a given oblique image is not constant. In one illustrative example, pixels in the lower half of an oblique image may have a scale of approximately 2 feet per pixel (as the lower half of the camera field of view is physically at a closer distance from the camera sensor) while pixels in the upper half of the same oblique image may have a scale of approximately 5 feet per pixel (as the upper half of the camera field of view is physically at a farther distance from the camera sensor). This behavior can also be referred to as the ground sample distance (GSD) associated with an oblique aerial image, or the pixels thereof. For instance, pixels in the foreground of an oblique aerial image may have a smaller GDS than pixels in the background of the oblique aerial image. In an illustrative example, a building near the foreground of an oblique image may have a GSD of 5 cm/pixel, while a building near the background of the oblique image may have a GSD of 30 cm/pixel.

The perspective distortions and variations in scale/GSD both within individual oblique images and across different oblique images can make it difficult or impossible to use oblique aerial imagery for direct size and distance comparisons, without first performing normalization or otherwise converting between the different GSD and perspective at the two different locations that are to be compared within an oblique image or across multiple oblique images. In some aspects, orthogonal imagery can be approximately taken to use a single, consistent scale both within individual orthogonal images and across the different orthogonal images captured in a dataset comprising a plurality of orthogonal images. By contrast, oblique imagery can be approximately taken as having an infinite number of local scales. Additional processing, normalization, and/or geometric corrections may therefore be required before existing techniques of image stitching can be applied for oblique imagery datasets. In some cases, oblique imagery viewers do not perform stitching to generate a composite oblique image for presentation to a user for visualization and manipulation. However, oblique imagery datasets may include thousands of different oblique images of an area of interest, and are not useful or are very cumbersome and challenging to interact with, view, and interpret without a viewer system that provides some form of view-oriented context (e.g., also referred to as a scene or geographic scene) to arrange and relate the individual oblique images with respect to one another. For example, the view-oriented context can correspond to different types of scenes, events, occurrences, objects, natural and/or artificial features and structures, etc., that are located within a geographic area. In some examples, the view-oriented context for a scene can correspond to various scenes, such as an emergency response scene, a natural disaster scene, a crime scene, a traffic scene, an urban scene, a suburban scene, a nature scene, a topographical scene, etc. As such, there is an additional need for systems and techniques that can be used to more effectively and more efficiently provide visualization and manipulation of a geographic scene view for an area of interest (e.g., an imaged area) that is represented within a plurality of individual, non-composite oblique aerial images. There is a further need for systems and techniques that can be used to provide visualization and manipulation (e.g., panning, rotation, etc.) of an oblique imagery scene without requiring computationally complex and time-consuming normalization and/or stitching image processing operations to be performed to first generate a composite image that may be used as the basis for the oblique scene viewer.

The present technology includes systems, methods, and computer-readable media (also referred to as “systems and techniques”) for solving these problems and discrepancies. For example, disclosed are systems and techniques that can be used to provide visualization and manipulation of geographic scene views of non-composite oblique imagery datasets (e.g., without generating a composite image from the plurality of oblique images included within an oblique imagery dataset). The individual oblique images can be organized and displayed to a user as a geographic scene corresponding to the area of interest that is imaged by or within the plurality of oblique images of the oblique imagery dataset. For example, the organization and presentation of the oblique images as a geographic scene can approximate the experience of viewing and interacting with (e.g., manipulating the view by panning, rotating, zooming, etc.) a true composite image.

For example, the non-composite oblique imagery viewer described and referred to herein can be configured to determine the configured or desired view perspective or viewpoint into the geographic scene, based on one or more user inputs to a graphical user interface (GUI) of the oblique viewer, and can automatically and in substantially real-time identify, fetch, and display the corresponding portion(s) of a best-fit or best-match singular oblique image. For example, the visualization and manipulation of a composite or stitched geographic scene can be simulated or approximated by the systems and techniques described herein, based on using a best-fit approach to identify the individual oblique image that most closely matches to the current view perspective information or current view perspective parameters that are set for or within the oblique imagery viewer by a user.

In particular, systems and techniques are described herein for the visualization of non-composite oblique imagery scene views using additional three-dimensional (3D) model, structure, scene, etc., data as supplemental information for ensuring a consistent rendering and depiction of various annotation feature overlays that are drawn on top of an oblique imagery scene view by a user. For example, the oblique angle associated with capturing oblique images can give the appearance of a 3D view, despite the oblique image itself being a two-dimensional photograph (e.g., a grid of pixels with dimensions H×W, etc.). In other words, the tilted or angled viewing perspective associated with oblique aerial imagery can be seen to create the appearance of a 3D view of the imaged scene or area of interest, particularly when compared to the top-down orthographic view that is commonly utilized in mapping and visualization systems (as these top-down views compress or obscure the vertical height dimension of the area and objects being imaged).

Due to the 3D-like appearance or effect that is often associated with viewing oblique aerial imagery, it can be desirable for users (e.g., viewers of oblique aerial imagery of an area of interest) to add various annotations, notations, and/or other feature data overlays on top of an oblique aerial image (e.g., also referred to as a displayed oblique image, a currently displayed oblique image, a currently viewed oblique image, etc.). For example, annotation features added by a user or viewer of an oblique image may include various lines that are used to measure a distance, length, or other real-world dimensional value of an object that is visible in the oblique image (e.g., a measurement line to determine or indicate the length of a building, the depth of a building, the offset between a building and a road, the length or width of a sidewalk or access road, and so on, etc.). In another example, the annotation features added by a user or viewer of an oblique image may include various polygons or enclosed shapes/geometries that are used to measure a size or area of an object that is visible in the oblique image (e.g., the area of a parking lot, the area of a building's roof, the area of one face of a building, the area of permeable or non-permeable surface shown within the oblique image or area of interest, etc.).

Because individual oblique images are intrinsically tied to a particular viewpoint or perspective (e.g., each oblique image can be characterized by one or more of a center point coordinate, a heading or orientation angle of the oblique camera or imaging device, a tilt/view angle of the oblique camera or imaging device, an imaging height, various ground sample distances (GSDs) or pixel resolutions, etc.), an annotation or other feature overlay that is created by a user may initially be context-dependent and accurately represented only within the particular viewpoint parameters or viewpoint characteristics of the displayed oblique image (e.g., currently display oblique image presented or otherwise output for presentation to the user, an oblique image of interest for the user, etc.). For example, an annotation line or other feature overlay that is created on an oblique image taken with a North-facing heading/orientation angle will not necessarily be correctly or accurately depicted if the same annotation line is overlaid on another oblique image of the same scene but taken from an East-facing heading/orientation angle, a South-facing heading/orientation angle, or a West-facing heading/orientation angle, etc.

Accordingly, described herein are systems and techniques that can be used to automatically correlate and project/reproject annotations and other feature data overlays from a first oblique image perspective of a scene, to a second, different oblique image perspective of the same scene. Advantageously, by projecting and/or reprojecting the annotations or feature overlays between different dimensionality spaces (e.g., 3D to 2D, 2D to 3D, etc.) and/or between different viewpoints and other context-dependent parameters, the systems and techniques can improve the comprehensibility of a user who attempts to view the same annotation or feature overlay across different visualization systems, viewpoints, and/or representations of a same underlying geographic area. For example, the disclosed projection and/or reprojection of annotations or other feature overlays can be used to provide consistency and improved comprehensibility to a user who views an annotation or other feature overlay while switching between a 3D visualization system and a 2D oblique image visualization system, and vice versa. As will be described in greater detail below, in some embodiments, the visualization and presentation of the annotation feature overlays for various non-composite oblique image views of the same scene (or area of interest) can be implemented based at least in part on using three-dimensional model data or other supplemental 3D information of the underlying scene/area of interest. For example, the underlying 3D model data or supplemental 3D information can be used for automatically transforming one or more oblique imagery annotation feature overlays from a first (e.g., source) oblique viewpoint or perspective, to a second (e.g., target) oblique viewpoint or perspective, and vice versa.

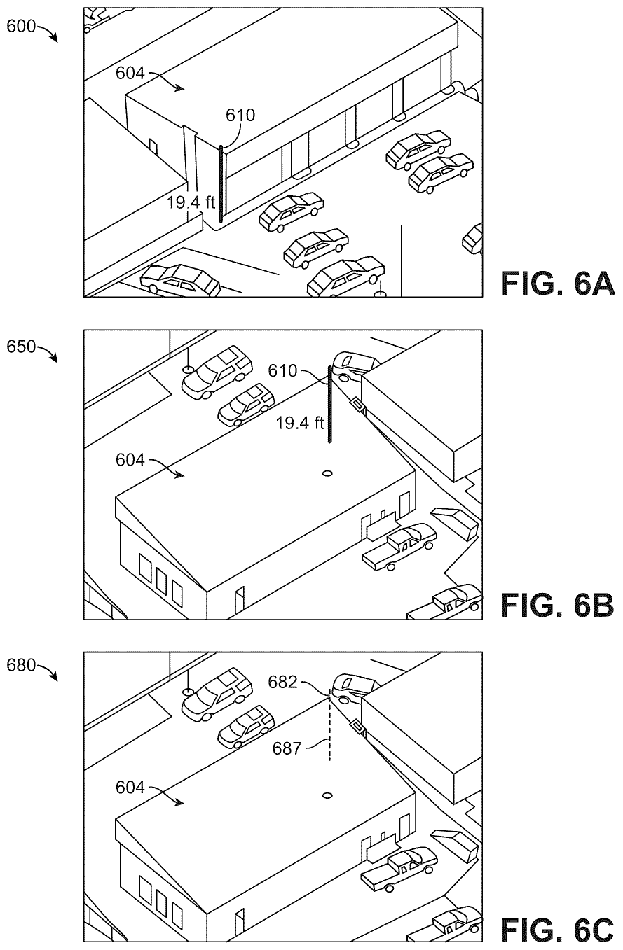

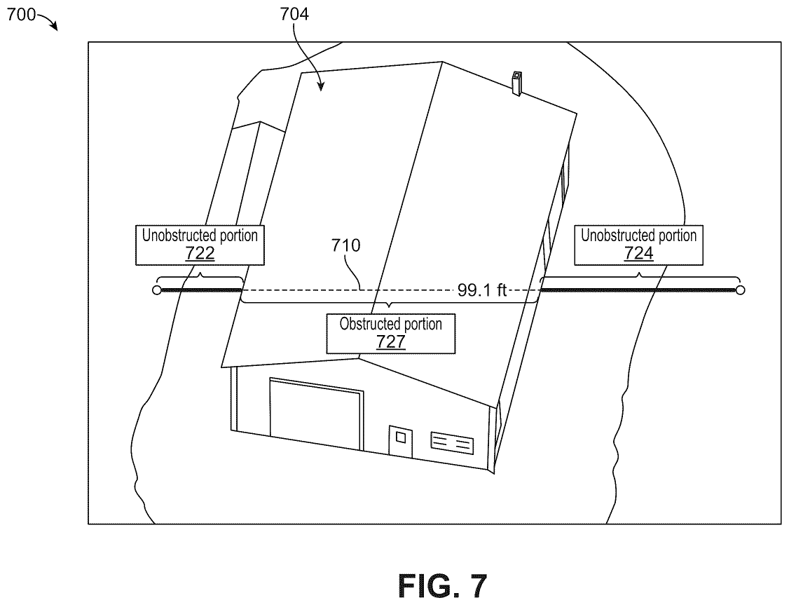

Described below with respect to FIGS. 2-5 is an example of a non-composite oblique imagery viewer system, which can used for the implementation of the disclosed oblique annotation feature overlay transforms between various oblique viewpoints using supplemental 3D model data or other 3D information. Following the description of the example non-composite oblique imagery viewer system of FIGS. 2-5, the disclosure turns to FIGS. 6 and 7 and a description of example systems and techniques for providing the disclosed oblique annotation feature overlay transforms between various oblique viewpoints using supplemental 3D model data or other 3D information. Example Non-Composite Oblique Imagery Viewer System

For example, FIG. 2 is a diagram illustrating an example of geographic scene visualization 200 using configured or requested view perspective information indicative of a user's desired view of (e.g., into) a geographic scene 210 that corresponds to a plurality of non-composite oblique aerial images. For example, the geographic scene 210 may correspond to a plurality of singular or individual (e.g., discrete) oblique aerial images that each depict a subset or respective portion of the larger area of the geographic scene 210. The plurality of individual oblique aerial images may be overlapping or non-overlapping, and can be included in one or multiple oblique imagery datasets and/or oblique imagery capture sessions, etc.

In some examples, an oblique imagery viewer for non-composite oblique imagery can be implemented based on view perspective information corresponding to or otherwise indicative of a desired view of the geographic scene 210. As illustrated in the example of FIG. 2, different configurations of desired scene views are represented as the user views 222, 224, 226, 228, and 229. The desired scene views may also be referred to as scene view configurations, requested scene views, requested viewpoints, requested scene perspectives, etc.

The different scene views 222-229 can each correspond to a respective set of view perspective information, indicative of information that uniquely characterizes the subset of the overall geographic scene 210 that is requested for viewing by a user of the oblique imagery viewer. For instance, the scene view 222 can correspond to the view perspective information 242; the scene view 224 can correspond to the view perspective information 244; the scene view 226 can correspond to the view perspective information 246; the scene view 228 can correspond to the view perspective information 248; and the scene view 229 can correspond to the view perspective information 249; etc.

Different scene views can correspond to different locations of the area or region within the geographic scene 210 that the user wishes to view in the display output of the non-composite oblique imagery viewer described herein. For example, the user can input one or more scene manipulation commands or otherwise indicate one or more scene manipulation or visualization operations to cause the oblique imagery viewer to update the display output from a first scene view to a second scene view, both within the same overall geographic scene 210 that corresponds to the underlying set of individual oblique aerial images. The scene manipulation commands for changing between different views can include one or more of a horizontal translation (e.g., shifting the center point of the desired scene view right or left, corresponding to increasing or decreasing the x-coordinate of the scene view center coordinate (x,y)); a vertical translation (e.g., shifting the center point of the desired scene view up or down, corresponding to increasing or decreasing the y-coordinate of the scene view center coordinate (x,y)); a rotation (e.g., changing the orientation or heading angle of the desired scene view to an larger or smaller angular value, corresponding to rotating clockwise or counter-clockwise); a change in zoom level (e.g., zooming in or out on the geographic scene 210, corresponding to increasing or decreasing the zoom level); a change in the look angle of the oblique imagery (e.g., tilting up or down relative to the ground surface, corresponding to increasing or decreasing the vertical look/tilt angle, which may be the same as or mapped to the view angle used to capture an oblique aerial image).

Each of the configured or requested user views 222-229 can be associated with a corresponding view perspective information 242-249. Each set of view perspective information 242-249 can include the same fields, with respective values corresponding to the particular user view associated with the set of view perspective information. For example, each set of view perspective information 242-249 can include a position or center point coordinate (e.g., an (x,y) coordinate) of the central point of the corresponding scene view 222-229, respectively.

In some examples, the coordinate system used for the position or center point information included in the view perspective information 242-249 can be a constant or baseline coordinate system (e.g., a world coordinate system) that is used to geo-reference the different possible scene views and the underlying plurality of non-composite oblique aerial images to the same coordinate system and reference point(s). In some examples, the view perspective information 242-249 can include center point (x,y) coordinates that utilize the same coordinate system that is used to represent location or position information uniquely associated to each one of a plurality of oblique aerial images captured for the geographic scene area 210. For example, the common coordinate system can be a native coordinate system used for logging position information of each oblique aerial image at the time of capture during aerial oblique imagery surveying operations, etc. In some cases, the common coordinate system can be a converted coordinate system that is different from the coordinate system used to log position or location information of each oblique aerial image at its time of capture (e.g., such that the oblique aerial images and the scene view perspective central points are both converted to the common coordinate system. In some examples, the common coordinate system can be implemented as a geographic coordinate system (GCS) associated with a GIS platform or GIS viewer application used by the non-composite oblique aerial imagery viewer.

The view perspective information 242-249 can further include a vertical look angle of the corresponding scene viewpoint configuration 222-249; a horizontal heading angle or orientation of the corresponding scene viewpoint configuration 222-249; and a resolution/zoom level of the corresponding scene viewpoint configuration 222-249. In one illustrative example, the scene viewpoints 222 and 224 (and the corresponding view perspective information 242 and 244, respectively) can include the same y-coordinate value of the center point and a different x-coordinate value of the center point. The view perspective information 242 and 244 may additionally include the same look angle value, based on the scene views 222 and 224 having the same vertical look/tilt angle as one another; may additionally include the same heading angle value, based on the scene views 222 and 224 having the same orientation (e.g., north-facing) angle as one another; and may additionally include the same resolution/zoom level value as one another, based on the scene views 222 and 224 having the same zoom level as one another (e.g., scene views 222 and 224 are of equal size).

In another example, the view perspective information 248 can include a different position/(x,y) center point coordinate than the view perspective information 242, based on the scene views 222 and 228 having different central point locations within the geographic scene area 210; can include a different resolution/zoom level than the view perspective information 242, based on the scene view 228 being smaller (e.g., higher zoom level) than the scene view 222; and can have the same orientation/heading angle as the view perspective information 242, based on the scene views 222 and 228 both having the same orientation (e.g., north-facing) angle as one another.

In another example, the view perspective information 246 can include a different position/(x,y) center point coordinate than the view perspective information 242, based on the scene views 222 and 224 having different central point locations within the geographic scene area 210; can include a different resolution/zoom level than the view perspective information 242, based on the scene view 226 being larger (e.g., smaller zoom level) than the scene view 222; and can have the same orientation/heading angle as the view perspective information 242, based on the scene views 222 and 226 both having the same orientation (e.g., north-facing) angle as one another.

In yet another example, the view perspective information 249 can include a different position/(x,y) center point coordinate than the view perspective information 242, based on the scene views 229 and 224 having different central point locations within the geographic scene area 210; can include a different heading angle from the view perspective information 242, based on the scene view 229 having a different orientation angle (e.g., east-facing) than the orientation angle of the scene view 222 (e.g., which is north-facing); and can have a same resolution/zoom level as the view perspective information 242, based on the scene view 229 and the scene view 222 being of equal size (e.g., same zoom level) as one another within the geographic scene area 210.

In some examples, the view perspective information 242-249 corresponding to a user configuration or request for the scene view area 222-249 within the overall geographic scene area 210 can be obtained or determined based on one or more user inputs to the non-composite oblique imagery viewer. For example, user inputs to adjust or manipulate the scene view area displayed in the GUI of the oblique viewer may be received as one or more mouse or pointer/cursor inputs, one or more keyboard inputs, or various combinations thereof. The user inputs corresponding to manipulations or changes to the displayed scene view area within the oblique viewer GUI can be used to determine the view perspective information 242-249, which itself may be used to determine a best-fit matching oblique image to display to the user, as will be described in greater detail below.

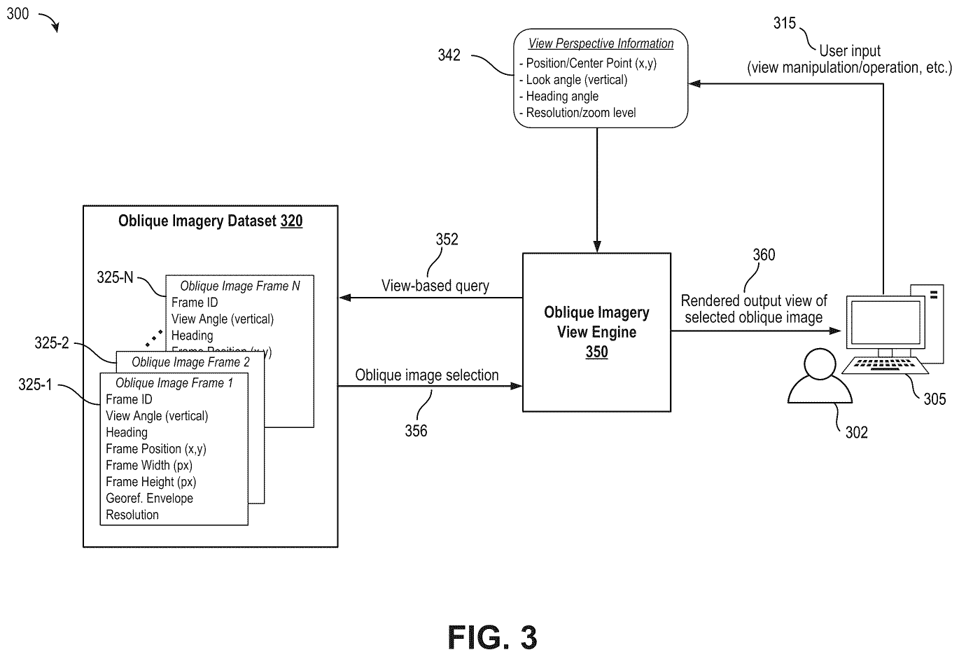

FIG. 3 is a diagram illustrating an example of an oblique imagery visualization system 300 configured to use view perspective information and a corresponding view-based query for generating a rendered output view of a selected non-composite oblique image, in accordance with some examples. The oblique imagery visualization system 300 can include an oblique imagery view engine 350 and one or more oblique imagery datasets 320. Each oblique imagery dataset 320 can include a respective plurality of oblique aerial images. For instance, in the example of FIG. 3, the oblique imagery dataset 320 can include a quantity N of individual (e.g., singular, discrete, etc.) oblique aerial images 325-1, 325-2, . . . , 325-N. In some cases, the plurality of N oblique aerial images within the oblique imagery dataset 320 may be obtained in the same surveying or oblique imaging capture session. In some examples, the plurality of N oblique aerial images within the oblique imagery dataset 320 can be obtained in multiple different survey or oblique imagery capture sessions, including survey/capture sessions performed on different dates, with different imaging equipment, with different survey patterns or operational parameters, etc. In some examples, the individual oblique images 325-1-325-N within the oblique dataset 320 can correspond to respective portions or areas within the same, larger geographic region or geographic scene area. For example, the oblique images 325-1-325-N may each correspond to a respective imaged area comprising a subset of the geographic scene area 210 of FIG. 2, etc.

In some cases, each oblique image of the plurality of oblique images 325-1-325-N within the oblique dataset 320 can be identified with respective oblique image frame information. For example, each oblique image of the plurality of oblique images 325-1-325-N can be identified and stored (e.g., within the oblique dataset 320, or a database storing the oblique dataset 320, etc.) with some or all of: a frame identifier (ID) or unique file name that uniquely identifies each individual oblique image 325-1-325-N of the plurality of oblique images in the dataset 320; a look angle (e.g., a vertical tilt angle corresponding to the oblique imaging angle <90 degrees that was used to capture the respective oblique image—also referred to as a view angle); a heading angle or orientation angle used to capture the respective oblique image (e.g., provided as an angular value between 0-360 degrees, provided as one of set of discrete and pre-defined angular values such as 45 degree increments from 0-360, provided as one of a set of discrete and pre-defined angular indications such as the cardinal directions north, south, east, west, etc.); a frame position in (x,y) coordinates; a frame width in pixels; a frame height in pixels; a georeferenced envelope; and a resolution, zoom level, and/or GSD associated with the respective oblique image frame or portions thereof; etc.

As noted previously, the oblique image frame information associated with each oblique image 325-1-325-N in the oblique imagery dataset 320 can utilize the same coordinate system and/or georeferenced coordinate positions as are used for representing the central point (x,y) coordinates of the user's requested or configured scene view perspective (e.g., such as the scene view perspectives 222-229 of FIG. 2, etc.). Based on the same coordinate system being used for each oblique image 325-1-325-N and the requested view perspective information 342 for the rendered output to be displayed by the oblique imagery view system 300, the oblique imagery view engine 350 can perform best-fit matching to identify and select one oblique image from the plurality of oblique images in the dataset 320 as the best fit match that most closely corresponds to the requested scene view perspective 342.

In some examples, the scene view perspective information 342 shown in FIG. 3 can be the same as or similar to the scene view perspective information 242-249 shown in FIG. 2 and described previously above. For example, the scene view perspective information 342 can be based on one or more user inputs 315 indicative of a scene view manipulation or operation for changing or adjusting the displayed view of the oblique imagery geographic scene from the oblique imagery system 300. The user inputs 315 can be received from a user 302 of the oblique viewer system 300. For example, the user 302 can be associated with a user computing device 305 that is configured to communicate with or otherwise receive data of a rendered output view 360 of a selected oblique image from the oblique imagery view engine 350. The rendered output view 360 of the oblique image can be displayed to a user via a GUI of the system 300, which may be presented or rendered to the user 302 via a GUI shown on one or more displays of or associated with the user computing device 305. User input devices of the user computing device 302 can include a keyboard, mouse, trackpad, touchpad, touchscreen, etc., and can receive the one or more user inputs 315 from the user 302, where the received user inputs 315 are indicative of the requested or desired view manipulations or operations to adjust, change, or update the oblique imagery scene view of the rendered output 360 from the oblique imagery viewer system 300.

In some cases, each user interaction or user input 315 to the user computing device 305 running the oblique viewer system 300 and/or the oblique imagery view engine 350 can correspond to a new (e.g., current) view perspective information 342 being generated or obtained, and provided as input to the oblique imagery view engine 350.

For each input of view perspective information 342 received by the oblique imagery view engine 350, the oblique imagery view engine 350 can be configured to perform best-fit matching between the view perspective information 342 and the individual oblique images 325-1-325-N within the oblique dataset 320. In some examples, the oblique imagery view engine 350 can use the view perspective information 342 to generate or determine a corresponding view-based query 352 that can be used to query the oblique imagery dataset 320 to find the best-fit matching oblique image having an imaged perspective or imaged viewpoint (e.g., as indicated by the oblique image frame information 325-1-325-N described above) that most closely matches the requested viewpoint into the geographic scene indicated by the user input 315 to the oblique viewer system 300 GUI on the user computing device 305.

The plurality of oblique images 325-1-325-N can be stored in the oblique dataset 320 without relational links between the different oblique images. The view-based query 352 can include or be indicative of some, or all, of the view perspective information 342 provided to the oblique imagery view engine 350 in order to determine an update for the rendered output view 360 of an oblique image best matching to the user 302's requested viewpoint into the overall oblique imagery geographic scene. The oblique imagery view engine 350 can use the user's requested perspective as indicated by the view perspective information 342 (e.g., position, look angle, heading, zoom level/resolution) to determine the best-matching or best-fit oblique image within the oblique dataset 320. For example, the view-based query 352 may include the user's requested position, look angle, heading, and zoom level values from the view perspective information 342, which can be compared and analyzed against the corresponding position, view angle, heading, and resolution information stored in the dataset 320 for each respective oblique image of the plurality of oblique images 325-1-325-N.

For example, the center point position or (x,y) coordinate of the view perspective information 342 can be encoded in the view-based query 352 and compared/analyzed against the respective frame center point position for each oblique image 325-1-325-N within the oblique dataset 320. In one illustrative example, the comparison of center point positions can be based on calculating a distance between the (x,y) center point coordinate of the view perspective information 342, and the (x,y) center point coordinate of each oblique image 325-1-325-N (e.g., based on the same coordinate system being used for both the view perspective information 342 and the oblique image dataset 320 positions). In some examples, the best-match oblique image selection 356 can be selected, identified, or otherwise determined as the oblique image in the dataset 320 having the shortest (e.g., smallest) straight-line distance from the oblique image center point to the requested view perspective information 342 center point. For example, in some aspects, the best-match oblique image selection may have a distance of a single pixel from the oblique image center point to the requested view perspective information 342 center point (e.g., the minimum possible distance that may be determined by the best-match oblique image selection 356 can be zero). In some examples, the minimum possible distance that may be determined by the best-match oblique image selection 356 may correspond to a distance of a single pixel (e.g., one pixel) from the oblique image center point to the requested view perspective information 342 center point. In some cases, a maximum possible distance that may be determined by the best-match oblique image selection 356 can be equal to and/or may otherwise correspond to one or more dimensions and/or boundaries of the geographic area (e.g., area of interest) represented within the oblique imagery dataset 320. For example, the maximum possible distance that may be determined by the best-match oblique image selection 356 may be equal to or correspond to a height or width of the geographic scene area (e.g., in pixels or other units), such as a height or width of the geographic scene area 210 of FIG. 2, etc.

In some examples, the look angle of the view perspective information 342 can be used to filter the oblique image dataset 320 to only perform the center point distance calculation for the subset of oblique images in that dataset 320 having a matching look angle (e.g., the view angle of the oblique image). In such examples, the distance from the center point (x,y) coordinate of the view perspective information 342 to an oblique image center point (x,y) coordinate is calculated if the oblique image has a view angle that matches the specified vertical look angle in the view perspective information 342. The distance calculation may be skipped (e.g., not performed) if it is determined during the filtering step that the oblique image was captured at a view angle that does not match and/or differs from the look angle indicated in the view perspective information 342.

Similarly, the heading angle indicated in the view perspective information 342 may additionally, or alternatively, be used to perform an initial filtering of the plurality of oblique images 325-1-325-N within the oblique dataset 320, to identify the subset of oblique images that were captured with an orientation that matches the specified heading angle. For example, the center point distance calculation can be performed to identify the best-fit matching oblique image selection 356 from only the subset of oblique images within the dataset 320 that are determined in the first stage filtering to have a capture orientation that matches the specified heading angle of the view perspective information 342. Skipping the distance calculation and comparison for oblique images with a capture orientation that does not match the indicated heading angle of the view perspective information 342, and/or for oblique images with a vertical view angle that does not match the indicated tilt angle of the view perspective information 342 can improve the efficiency and speed of the best-fit oblique image selection 356 by culling the non-matching oblique image candidates that can be eliminated from best-fit match consideration based on at least one variable other than the center point distance.

In some examples, the oblique image selection 356 can return information indicative of one, singular oblique image within the dataset 320 that was identified as having the shortest straight-line distance between its respective center point and the indicated center point of the view perspective information 342. In some examples, the best-fit matching evaluation can utilize one or more additional criteria to choose between multiple oblique images having the same straight-line distance to the indicated center point coordinate from the view perspective information 342.

In some cases, the oblique imagery view engine 350 can be further configured to generate the rendered output view 360 of the oblique imagery scene for the indicated view perspective information 342, based on using at least a portion of the image data contained in the selected best-fit match oblique image 356. For example, the oblique imagery view engine 350 can generate the rendered output view 360 using at least a portion of the best-fit match oblique image 356, where the portion of the image data to be used in the rendered output view 360 is determined based on the view perspective information 342.

For instance, the view perspective information 342 may specify a resolution/zoom level that is greater than the native zoom level of the selected oblique image 356 as captured. The oblique imagery view engine 350 may generate the rendered output view 360 based on cropping the selected oblique image 356 according to the requested zoom level of the view perspective information 342, and the native/captured zoom level of the selected oblique image 356. The oblique imagery view engine 350 can additionally perform the cropping within the frame of the selected oblique image 356 (e.g., with the oblique image frame determined based on the x,y center point position and the frame height and width information stored for the selected oblique image 356 in the dataset 320), such that the desired position is centered in the rendered output view. In other words, the selected oblique image 356 is identified as the oblique image with a natural center point (e.g., the center point of the entire oblique image frame) that is nearest to the requested center point specified in the view perspective information 342. However, the distance between center points may, in many cases, be a non-zero value.

A non-zero distance between the natural center point of the selected oblique image 356 as captured, and the specified center point for the view perspective information 342, can trigger the oblique imagery view engine 4350 to perform the cropping such that the center point of the cropped, rendered output view 360 has the same (x,y) center point as was requested in the view perspective information 342.

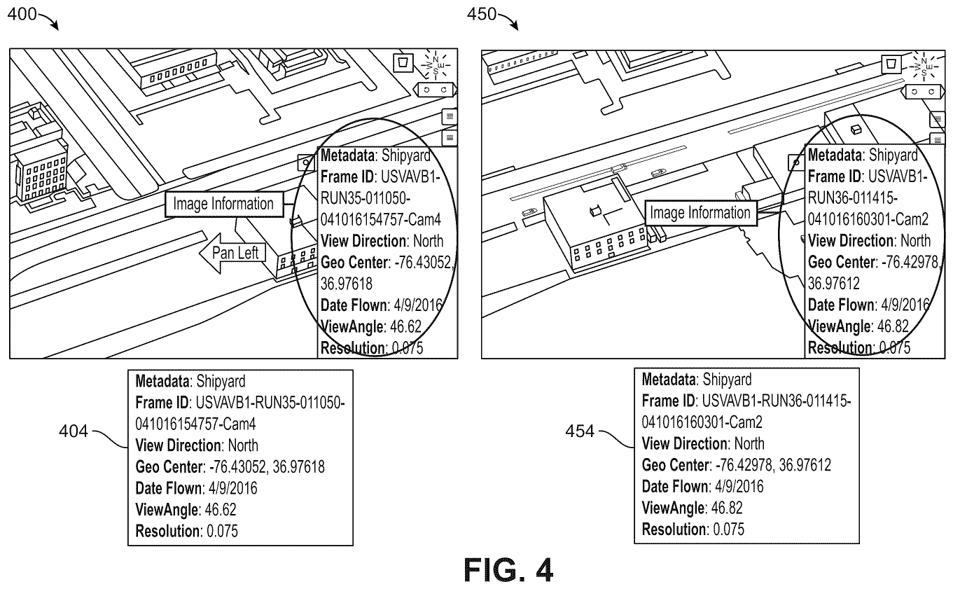

FIG. 4 is a diagram illustrating an example of a panning operation corresponding to first view frame 400 and a second view frame 450 of a geographic scene visualization, wherein the first and second view frames are based on separate and non-composite oblique images, in accordance with some examples. For instance, the first view frame 400 can correspond to the rendered output view 360 of the oblique image viewer system 300 of FIG. 3. In particular, the first view frame 400 can be the rendered output view 360 prior to receiving a user input indicative of a manipulation operation to move (e.g., pan) the scene view to the left. The first view frame 400 may be associated with the first oblique image frame information 404, which can be the same as or similar to the oblique image frame information shown in FIG. 3 and described above with respect to the oblique images 325-1-325-N included within the oblique dataset 320.

The second view frame 450 corresponds to the rendered output view of the oblique image viewer system after receiving the user input to pan left, and after identifying a new best-fit matching oblique image given the new view perspective information determined after the pan left input is processed. In one illustrative example, the second view frame 450 can be associated with the second oblique image frame information 454, which can be the same as or similar to the oblique image frame information shown in FIG. 3 and described above with respect to the oblique images 325-1-325-N included within the oblique dataset 320.

Notably, the two oblique images 400 and 450 shown in FIG. 4 are not combined, stitched, or composited to support the transition between the two different viewpoint perspectives before and after the user pan left input. Instead, the two oblique images 400 and 450 remain separate, singular oblique images, that are identified and selected for output based on each image being determined to be the best-fit match for a current request scene view indicated in the user inputs. The distinction between the first and second oblique image frames 400 and 450 is illustrated in FIG. 4 by the slight shift in the perspective (e.g., viewing angle) between the first oblique image frame 400 and the second oblique image frame 450.

In some examples, the non-composite oblique imagery viewer system described herein may receive a user input indicative of a manipulation or change in the requested viewpoint into the geographic scene, and may determine that the most recently displayed oblique image (e.g., the best-fit matching oblique image for the requested viewpoint immediately prior to receiving the user input indicative of the manipulation or change) remains the best-fit matching oblique image for the new requested viewpoint after the user input indicating the requested manipulation or change. For example, if the currently displayed oblique image still best matches the desired viewing criteria after receiving user input(s) indicating a pan, rotation, or other manipulation of the scene view, the non-composite oblique imagery viewer can be configured to continue showing the same oblique image (with the cropping/zoom level adjusted as needed to match any change to the center point or zoom level in the updated desired viewing criteria).

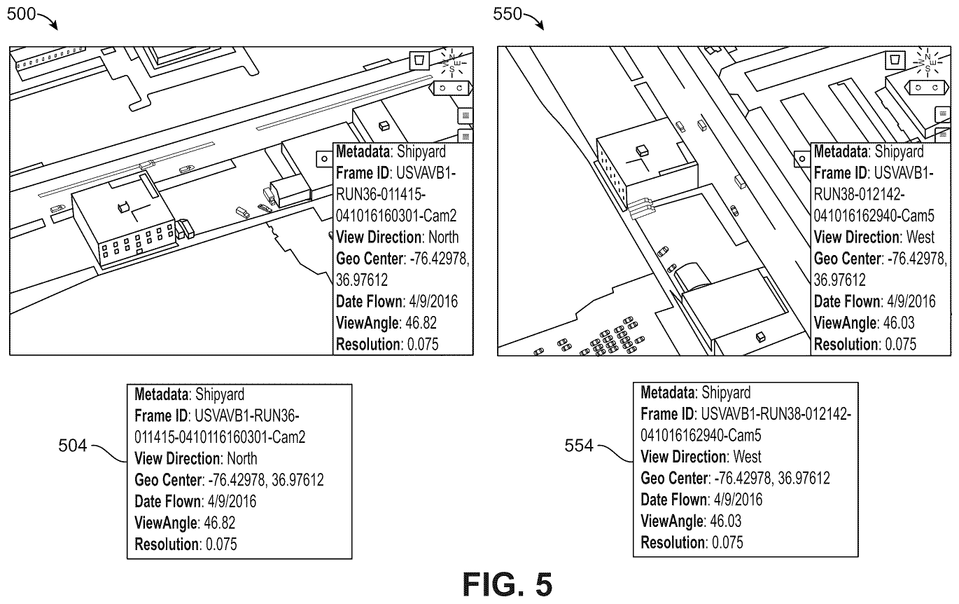

FIG. 5 is a diagram illustrating an example of a rotation operation corresponding to a first view frame 500 and a second view frame 550 of a geographic scene visualization, wherein the first and second view frames are based on separate and non-composite oblique images, in accordance with some examples. For instance, the first view frame 500 can correspond to the rendered output view 360 of the oblique image viewer system 300 of FIG. 3. In particular, the first view frame 500 can be the rendered output view 360 prior to receiving a user input 315 indicative of a manipulation operation to rotate the scene view to a new desired heading (e.g., orientation angle). The first view frame 500 can be associated with a first oblique image frame information 504. In some examples, the first view frame 500 of FIG. 5 is the same as the second view frame 450 of FIG. 4, and the first oblique image frame information 504 of FIG. 5 is the same as the second oblique image frame information 454 of FIG. 4.

In some aspects, the second view frame 550 of FIG. 5 can correspond to the rendered output view of the oblique image viewer system after receiving and processing the user input to rotate the viewpoint orientation 90 degrees clockwise. The second view frame 550 can be associated with second oblique image frame information 554, which can be the same as or similar to the oblique image frame information shown in FIG. 3 and described previously above with respect to the oblique images 325-1-325-N included within the oblique dataset 320 of FIG. 3.

In one illustrative example, the second oblique frame 550 is selected and obtained as a completely different oblique image than the first oblique frame 500. The second oblique frame 550 can be an oblique image that was taken from the same perspective requirements as the first oblique frame 500, except with the direction (heading/orientation angle) of the viewpoint changed according to the user input indicating the desired manipulation of a 90 degree clockwise rotation.

### Annotation Feature Overlay Transforms Between Oblique Viewpoints Using 3D Model Data

As noted previously, disclosed herein are systems and techniques that can be used for the visualization of one or more annotation feature overlays that are rendered, transformed, reprojected, and/or otherwise adjusted to remain accurate and consistent when shown on different oblique images (with respective different oblique perspectives) of the same geographic scene or area of interest. For example, the systems and techniques can utilize three-dimensional model data or other supplemental 3D information corresponding to the geographic scene or area of interest that is depicted in an oblique image (or series of oblique images). The 3D model data or other supplemental 3D information can be used to determine one or more geo-referenced coordinates corresponding to each annotation feature that is to be overlaid on an oblique image view of the scene. Based on the geo-referenced coordinates of each annotation feature, as determined from the 3D model data or supplemental 3D information, each annotation feature can be rendered with geospatial relationships and relative size and placement information maintained across different oblique imagery viewpoints of the scene or area of interest where the annotation feature was originally drawn, placed, anchored, etc.

In some examples, the annotation feature can be a notation or feature data that is added to an oblique image. The annotation feature may be added by a user, may be automatically generated and added, and/or may be added through various combinations of user interaction and automated generation or placement. In some cases, a single annotation feature may be added to a respective oblique image presented in the oblique image viewer (e.g., the oblique image viewer system 300 of FIG. 3, etc.). In some examples, one or multiple annotation features may be added to a respective oblique image presented in the oblique image viewer. In examples where multiple annotation features are shown for an oblique image, the multiple annotation features may be of the same type and/or may be of different types.

In some embodiments, the different types of annotation features (e.g., also referred to as annotation overlays, annotation feature overlays, feature data, feature data overlays, notations, notation overlays, etc.) can include, but are not limited to, one or more of a point or set of points (e.g., a coordinate point identified in the same (x,y) or (x,y,z) coordinate system used for the oblique images of the oblique imagery dataset 320 of FIG. 3, etc.); a line or set of lines; an area polygon or other enclosed area (e.g., facade polygons); and so on, etc. In some examples, annotation features may include or be paired/associated with corresponding text labels or other textual information. For example, an annotation point can be used to indicate or label a point of interest (POI) or mapping label data such as a building name, town name, city name, etc. The annotation point may itself include geo-referenced coordinate data for placement and localization of the annotation, and in some cases may further include the corresponding textual information to be displayed or stored as the text label information for the annotation point. In other examples, annotation point coordinate information can be stored separately from the corresponding textual label information for the annotation point. For instance, the textual label information for an annotation point (or other annotation features/annotation feature type(s)) may be stored as a separate, text type annotation feature that is rendered in combination with an associated annotation feature.

In other examples, the annotation feature may be a measurement line, indicative of a distance, length, dimension, etc., that is measured within the oblique image view currently displayed to a user of the oblique imagery viewer system 300. For example, FIG. 6A is a diagram illustrating an example of a first oblique image view 600 of a scene with an annotation feature overlay comprising a distance measurement line 610, in accordance with some examples. In the example of FIG. 6A, the first oblique image view 600 includes an oblique view (e.g., an oblique perspective/viewpoint) of an area of interest or scene that includes a building 604. The annotation feature 610 can be a distance measurement line corresponding to and indicative of a height of the building 604. For example, the annotation feature 610 can include the vertical measurement line and the associated textual label indicative of the measured or calculated height of “19.4 ft”.

In some aspects, the first oblique image view 600 can be associated with a corresponding oblique image view perspective information that includes some (or all) of the parameters that uniquely characterize the viewpoint used to capture the first oblique image view 600. For example, the first oblique image view 600 can be associated with corresponding oblique image frame viewpoint information that is the same as or similar to the respective oblique image frame viewpoint information stored in the oblique imagery dataset 320 for each of the oblique images 325-1, 325-2, . . . , 325-N. In some cases, the first oblique image view 600 can be associated with a corresponding user-requested view perspective information that caused the first oblique image frame to be fetched and displayed as the output first oblique image view 600 by the oblique imagery viewer system 300 of FIG. 3.

For example, the first oblique image view 600 can be associated with corresponding oblique image frame viewpoint information that is the same as or similar to the oblique image frame viewpoint information 404 or 454 of FIG. 4, and/or the oblique image frame viewpoint information 504 or 554 of FIG. 5, etc. In one illustrative example, the first oblique image view 600 can be associated with corresponding oblique image frame viewpoint information that is indicative of one or more (or all) of a center position or coordinate point, a vertical look angle, a horizontal heading/orientation angle, and a resolution/zoom level or GSD, etc.

In one illustrative example, the systems and techniques disclosed herein can be used to generate, render, and/or visualize annotation feature overlays for non-composite oblique aerial images, such that the annotation feature overlays appear to be embedded within the geographic scene or area of interest that is depicted across a series of different oblique images that are each taken from a corresponding different oblique view perspective (e.g., each associated with a corresponding oblique image frame viewpoint information such as the oblique image frame viewpoint information 404/454, 504/554, etc.). For example, the annotation features can be generated to include or associate with georeferenced coordinates for the placement of the annotation feature(s) within the geographic scene of interest, such that the annotation feature is correctly placed and localized relative to the objects within the geographic scene that is shown in a series of oblique aerial images.

In some embodiments, the annotation features can include or be based on georeferenced coordinates within the same, common georeferenced coordinate system that is used for the selection between individual non-composite oblique aerial images, as described above with respect to FIGS. 2-5. For instance, the annotation features can be generated, defined, and/or localized using one or more annotation feature coordinate values (e.g., (x,y) coordinates and/or (x,y,z) coordinates) that are generated using the same GIS-based or world coordinate system that is used to define the center point coordinates of the respective oblique viewpoints for the oblique image frames 325-1, 325-2, . . . , 325-N within the oblique imagery dataset 320 of FIG. 3, and that is used to define the center point coordinates of the user-requested view perspective information 342 of FIG. 3, etc.

For instance, in one illustrative example, the annotation feature comprising the distance (e.g., height) measurement line 610 of FIG. 6A can be represented using a geo-referenced (x,y) coordinate corresponding to the beginning of the height measurement line 610 and a second geo-referenced (x,y) coordinate corresponding to the end of the height measurement line 610. In another example, the annotation feature comprising the height measurement line 610 can be represented using one geo-referenced (x,y) coordinate and a length (e.g., 19.4 ft) of the height measurement line 610. For instance, the single geo-referenced (x,y) coordinate used for the representation of the height measurement line 610 may be the point where the height measurement line 610 intersects with the ground surface of the local geographic scene or area of interest that is depicted within the first oblique image frame 600 of FIG. 6A.

Based on the same, common geo-referenced or world coordinate system being used for the definitions associated with the first oblique image frame 600 (and its associated oblique viewpoint information, which includes a geo-referenced center point coordinate of the first oblique image frame 600) and the height measurement line annotation feature 610, the overlay of the height measurement line annotation feature 610 can be correctly localized relative to the features and objects shown in the first oblique image frame 600.

For instance, FIG. 6B is a diagram illustrating an example of a second oblique image view 650, which corresponds to a 180-degree orientation rotation from the first oblique image view 600 of FIG. 6A, with both the first oblique view 600 and the second oblique view 650 showing the same geographic scene/area of interest (e.g., the view of the building 604) and both including the height measurement line annotation feature overlay 610. For example, the first oblique image view 600 of FIG. 6A can correspond to a North-facing orientation viewing angle of the geographic scene including the building 604; the second oblique image view 650 of FIG. 6B can correspond to a South-facing orientation viewing angle of the same geographic scene including the same building 604.

In some embodiments, the height measurement line annotation feature overlay 610 is shown at different positions within the oblique view frames 600 and 650, but is shown at a constant/consistent georeferenced coordinate location. In other words, the location of the height measurement line annotation feature overlay 610 changes between the north-facing oblique viewpoint orientation of FIG. 6A and the south-facing oblique viewpoint orientation of FIG. 6B (e.g., the height measurement line 610 is at the lower left of the north-facing oblique image viewpoint frame 600, and is at the upper right of the south-facing oblique image viewpoint frame 650). The change in location of the annotation feature overlay 610 between different oblique frame viewpoints corresponds to the changes in perspective between the two different oblique frame viewpoints 600, 650 themselves.

Based on the height measurement line 610 being generated as a geo-referenced annotation feature overlay in the same world coordinate system as is used to define the center point coordinate location of both the first oblique image view 600 of FIG. 6A and the second oblique image view 650 of FIG. 6B, the relative placement and positioning of the height measurement line 610 annotation feature overlay is unchanged with respect to the center coordinate and the various objects shown in the two oblique image frame views 600 and 650. For example, the height measurement line 610 can be originally drawn (e.g., by a user) as an annotation feature overlay on the first oblique image view 600 of FIG. 6A. In this example, the north-facing orientation and the first oblique image frame viewpoint information can be referred to as the “source viewpoint” associated with the annotation feature overlay 610.

The annotation feature overlay (e.g., the height measurement line 610) can be generated and defined to be agnostic (e.g., independent or separate from) to the particular oblique image viewpoint and orientation that comprise the source viewpoint. For example, the height measurement line 610 can be defined as a georeferenced coordinate for the base of the height measurement line 610 (e.g., intersection of the height measurement line 610 with the ground surface or zero height of the measurement, etc.) and a length of the height measurement line 610. Neither the georeferenced coordinate nor the length used to define the height measurement line 610 exhibit a dependency on the particular oblique image viewpoint or orientation that is shown to the user as the source viewpoint at the time the annotation feature overlay (e.g., height measurement line 610) is drawn onto or otherwise generated for the first oblique image view 600 of FIG. 6A, and accordingly, can be automatically transformed and repositioned as appropriate for any oblique viewpoint or oblique aerial image that is available for the geographic scene or area of interest that includes the building 604.

For example, the oblique frame viewpoint information (e.g., the source viewpoint information referenced above) can be used to determine projection information to overlay the measurement line 610 onto the first oblique frame view 600 of FIG. 6A. The target viewpoint information indicative of the viewpoint used for the second, 180-degree rotated view of the second oblique frame view 650 of FIG. 6B can be used to determine projection information to overlay the same measurement line 610 onto the second oblique frame view 650 of FIG. 6B, with relative positioning between the measurement line 610 and objects within the depicted geographic scene (e.g., such as building 604, the vehicles near the outside of the building 604, etc.) are kept the same across both oblique frame views 600, 650.

While the georeferenced coordinate information used for the definition of each annotation feature overlay added to a geographic scene view of one or more oblique images can be used to adapt or re-project the annotation feature overlay to an appropriate position within each oblique viewpoint for the different oblique images of the geographic scene, the annotation feature overlay may, in at least some views, appear to interact improperly or incorrectly with one or more objects or elements depicted within the geographic scene and set of corresponding oblique images.

For instance, the height measurement line 610 is properly positioned in both FIG. 6A and FIG. 6B, but only appears to interact correctly with the building 604 and other related objects/elements in the scene in the first oblique view 600 of FIG. 6A. In the second oblique view 650 of FIG. 6B, the height measurement line 610 is still properly positioned (based on the use of the common georeferenced coordinate system), but does not interact properly with the building 604 object itself. For example, the height measurement line 610 would be blocked or obscured from view based on being positioned behind the solid structure of the building 604 in the rotated viewpoint of FIG. 6B. As such, a simple overlay rendering of the entire height measurement line annotation feature 610 can be unrealistic to a user or viewer, and may break the sense of immersion that would be otherwise provided by rendering the height measurement line annotation feature 610 as if the height measurement line 610 were embedded within the geographic scene of the oblique image (e.g., rendering the height measurement line 610 as if it were a physical object that can be blocked by and/or can block other objects and elements within the oblique image view, depending on the oblique viewpoint parameters used to capture the oblique image view of the scene with the annotation feature/height measurement line 610 embedded).

For instance, FIG. 6C is a diagram illustrating an oblique image view 680 that is the same as the second oblique image view 650 of FIG. 6B (e.g., rotated 180 degrees in orientation/heading angle relative to the orientation of the oblique viewpoint of the view 600 of FIG. 6A), with the annotation feature overlay 610 modified by the systems and techniques disclosed herein to indicate a non-obstructed portion 682 of the height measurement line and/or to indicate an obstructed portion 687 of the height measurement line.

In one illustrative example, only the non-obstructed portion 682 of the annotation feature height measurement line 610 is shown in the oblique image view 680 of FIG. 6C. In another illustrative example, different visual styles or representations may be used and both the non-obstructed portion 682 and the obstructed portion 687 may both be shown in the oblique image view 680 of FIG. 6C. For instance, when both operations are shown, the non-obstructed portion 682 of the height measurement line annotation feature can be shown as a solid line (e.g., the same as in the examples of FIG. 6A and/or FIG. 6B), and the obstructed portion 687 can be shown as a dashed line, a reduced opacity line, or other visual changes to show the non-obstructed portion 682 as a “real” or “visible” annotation feature overlay while showing the obstructed portion 687 as a “ghost” annotation feature overlay.

In some embodiments, the systems and techniques can use 3D model and/or other supplemental 3D information corresponding to the objects and elements shown within the geographic scene associated with the various oblique image views 600, 650, 680, etc., to calculate one or more obstructions between the annotation feature (e.g., measurement line 610) and the respective objects and elements of the geographic scene (e.g., such as the building 604, etc.). In some aspects, the 3D model data can be GIS-based or GIS-associated 3D modeling data for an area of interest that is mapped by the oblique imagery dataset 320 of FIG. 3. In some aspects, the 3D model data and/or supplemental 3D information can comprise or include Digital Surface Model (DSM) information corresponding to the area of interest that is also mapped by the oblique imagery dataset 320. Based on obtaining and utilizing the 3D model or DSM information of the same area of interest that is represented in the oblique image views and larger oblique imagery dataset (e.g., oblique dataset 320 of FIG. 3), the systems and techniques can automatically project and reproject the one or more annotation feature overlays 610 to appear as part of the oblique image being viewed. For instance, automatically calculating the intersection points or surfaces between each annotation feature and an element or object within the oblique image view (e.g., as determined based on intersecting the georeferenced coordinate definition of each annotation feature with the respective elements or objects defined in the 3D model or DSM data) can be used to determine the respective obstructed portion(s) and non-obstructed portion(s) of each annotation feature, for the particular oblique image and particular oblique viewpoint that is currently requested for output rendering and presentation to the user of the oblique viewer system. In some examples, the 3D model data can include 3D information of object surfaces within the scene. The object surfaces within the scene can correspond to various types of surfaces and/or 3D models, and can include object surfaces corresponding to floor plans (indoor floor plans, outdoor floor plans, various combinations thereof, etc.). In some examples, the 3D information of object surfaces can comprise at least a portion of the underlying data used to generate and/or render the 3D model for display or other output presentation to a user. In some examples, the 3D information of the object surfaces within the scene can comprise surface texture information of the 3D model, a 3D mesh or plurality of polygons that define a particular object surface within the 3D model, a portion of DSM data indicative of or corresponding to the object surfaces in the scene, etc. In some examples, the 3D information of the object surfaces in the scene can indicate a type of surface, a material of the surface, properties of the surface, etc.

In one illustrative example, the systems and techniques described herein can be used to provide automatic transformation and reprojection of annotation feature overlays into the respective oblique viewpoints associated with different oblique images of a geographic scene or area of interest, based on the annotation feature overlays being natively generated, processed, and transformed within the 3D world-space of the underlying 3D model, DSM information, or other supplemental 3D information obtained for the geographic scene and area of interest for the oblique viewer system. For instance, the 3D model or DSM information can be used to automatically calculate and project and/or reproject each annotation feature overlay that is added to a given oblique image and oblique viewpoint of an area of interest, in order to thereby update the representation of the annotation feature with masking information that allows the annotations or feature data to appear as a part of the oblique image being viewed (e.g., obstructed by, and/or obstructing one or more portions of objects, elements, etc., that are shown within the oblique images of the scene).

In some aspects, the height measurement line annotation feature 610 can be generated and processed as a 3D data element corresponding to the 3D model or DSM information. In this manner, the height measurement line can be initially created as an annotation line that is drawn in the three-dimensional space of the underlying 3D model/DSM data, which is automatically and in real-time projected from the 3D DSM model space into the 2D perspective of the currently displayed oblique viewpoint. For instance, if the height measurement line is drawn while the currently displayed oblique viewpoint is the first oblique image 600 of FIG. 6A, the height measurement line can be generated and first processed as native 3D data within the underlying 3D model/DSM data. After the height measurement line 610 is created in the native 3D space of the 3D DSM model for the geographic scene shown within the first oblique image 600, the 3D representation of the height measurement line can be projected into the 2D space of the first oblique image 600, based on parameterizing the projection by the oblique viewpoint information associated with each oblique image (e.g., the oblique viewpoint information shown in FIG. 3 for each oblique image 325-1-325-N in the oblique imagery dataset 320 of FIG. 3, which may include one or more (or all) of a center coordinate, view angle, heading/orientation angle, frame boundary and/or frame width and height, georeferenced envelope, resolution/zoom level, etc.).

When the oblique viewpoint is changed, such as for the 180-degree rotation between the oblique viewpoint of the first oblique image frame 600 of FIG. 6A and the rotated oblique viewpoint of both the oblique image frame 650 of FIG. 6B and 680 of FIG. 6C, the same 3D representation of the annotation feature 610 can be reprojected (e.g., projected) from the 3D DSM model space to the different, 2D oblique viewpoint space of the rotated image frame 650/680, using the corresponding oblique viewpoint information associated with the rotated oblique images 650/680.

For example, the annotation feature projection and reprojection from the 3D space associated with the 3D DSM model and/or the supplemental 3D information of the geographic scene and area of interest can be performed based on each oblique image (or series of oblique images) being associated with referenced geo-data that includes: a respective georeferenced location (e.g., coordinate) of the center focal point of the oblique image; a georeferenced boundary of the oblique image; and a perspective view angle of the camera used to capture the oblique image (e.g., POV or FOV information, etc.). In one illustrative example, the referenced geo-data of each oblique image used for the annotation feature overlay projection and reprojection from 3D model space to the 2D oblique viewpoint space can be the same as or similar to the oblique viewpoint information described previously above (e.g., can be the same as or included within the oblique viewpoint information stored in the oblique imagery dataset 320 of FIG. 3 for each respective one of the plurality of oblique images 325-1, 325-2, . . . , 325-N, etc.).

The oblique viewer system (e.g., oblique viewer system 300 of FIG. 3, oblique imagery view engine 350 of FIG. 3, etc.) can obtain as an additional input a desired view distance from the center point of the currently displayed oblique image. For example, the desired view distance can be a desired or user-configured/user-requested zoom level or resolution for the rendered output frame shown by the oblique viewer.

The oblique viewer system (e.g., oblique viewer system 300 of FIG. 3, oblique imagery view engine 350 of FIG. 3, etc.) can obtain 3D model information corresponding to or associated with the geographic area of interest, which may be the same as the geographic area of interest that is surveyed by and depicted within the set of oblique imagery in the oblique dataset 320. The 3D model information can be information associated with or defining a 3D model, including a 3D DSM model, 3D DSM information, and/or other supplemental 3D information that represents the objects and elements within the geographic area of interest in a geo-referenced 3D coordinate system/coordinate space.

The oblique viewer system (e.g., oblique viewer system 300 of FIG. 3, oblique imagery view engine 350 of FIG. 3, etc.) can use information indicative of a georeferenced boundary of the entire area of concern (e.g., georeferenced boundary of the area of interest), to determine or correlate a portion of the modeled 3D space to the oblique imagery area. In other words, the 3D model (e.g., DSM data) or other supplemental 3D information may be obtained for a larger area than the area of interest associated with the set of oblique imagery 320. In such examples, the systems and techniques can obtain information indicative of a georeferenced boundary of the entire area of interest that is represented by the set of oblique imagery 320, and can use the georeferenced boundary information to obtain or determine the corresponding subset of the larger 3D model that matches to the surveyed oblique imagery area of interest.

As noted previously, each annotation feature overlay can be received as a series of user inputs, or can be received as an already defined and created annotation feature overlay. Each annotation feature overlay can include georeferenced coordinates that fall within the georeferenced boundary of the image. An annotation feature can include one or multiple georeferenced coordinates. The annotation features can be implemented as lines, polylines, points, text, polygons or enclosed areas, boundary information, façade polygons, etc.).

Using the georeferenced boundary information of the area of interest, a corresponding 3D model can be constructed or obtained as a subset of a larger 3D model, as noted above. The resulting 3D model information comprises a 3D model of the area (and included objects, elements, etc.) that are included within the surveyed area of interest for the set of oblique imagery 320.

An annotation feature is drawn, generated, created, projected, etc., on to the 3D model of the area of interest, based on the corresponding georeferenced coordinates previously determined or obtained for each annotation feature. Subsequently, a 3D view or “camera” can be determined to generate the projected or reprojected 2D view for the current oblique viewpoint information for the currently displayed oblique image. For example, the 3D view or camera can be setup in a rendering or projection process that converts from the native 3D space of the model, to the 2D space suitable for output display by the oblique viewer system 300 (e.g., the 3D view or camera is used to generate the rendered 2D view of the 3D model, where the rendered 2D view is used for viewing the 3D model from a configured perspective (e.g., the oblique viewpoint) on the output display 305 of FIG. 3).

In one illustrative example, the 3D view or camera on the annotation feature within the 3D space of the 3D model can be configured or parameterized using the view perspective location requested by the user (e.g., the position/center point (x,y) coordinate from the view perspective information 342 of FIG. 3); the point of view of the oblique image being shown with the annotation feature overlaid (e.g., the oblique image viewpoint, POV/FOV of the oblique camera when capturing the oblique image, etc.); and the desired view distance configured or specified by the user input(s) (e.g., the resolution or zoom level, also from the view perspective information 342 of FIG. 3).

Based on the 3D camera view configured or parameterized with the view perspective information requested by the user in the view perspective information 342 and/or associated with the selected oblique image 356, a 2D projection of the 3D annotation feature is generated from the 3D model information. When multiple annotation features are present on the oblique image view (e.g., when multiple annotation features are visible in the same oblique frame to be shown to the user, the 3D-to-2D projection step can be performed a single time, to generate the projected 2D view of each of the multiple annotation features for the configured 2D oblique viewpoint information to be shown as output of the oblique viewer system 300).

In one illustrative example, the rendering and projection of the 3D annotation feature representation from the 3D DSM model space to the oblique viewpoint 2D perspective can include clipping one or more portions of the 3D annotation feature that are obstructed by or otherwise interfere or intersect with an object or element that is also represented in the 3D model.

For instance, when rendering and/or projecting the oblique viewpoint 2D view of the 3D model with the annotation feature representation of the height measurement line 610 for the rotated oblique image view 650/680 of FIGS. 6B/6C, the rendering engine associated with the 3D camera view can determine that the opaque surface(s) of the 3D object mapped to the building 604 will block or otherwise obstruct the obstructed portion 687 of the height measurement line from view. Based on the calculated obstruction identified from the 2D oblique viewpoint information and the 3D DSM model representation of the scene and the height measurement line 610, the rendered output for the 2D oblique view of the height measurement line 610 may include only the visible, non-obstructed portion 682, which can then be overlaid directly on top of the 2D oblique image 650, 680 to provide the appearance of the height measurement line 610 being behind the building 604 (e.g., based on not including in the rendered output/3D-to-2D projection the obstructed portion 687).

FIG. 7 is a diagram illustrating another example of an oblique image view 700 of a scene with an annotation feature overlay comprising a distance measurement line 710 rendered based on using 3D perspective and obstruction information of the scene to determine obstructed and non-obstructed portions of the distance measurement line, in accordance with some examples. For instance, the oblique image view 700 includes a building object (e.g., a barn) 704, shown from a respective oblique viewpoint. For an annotation feature overlay comprising a horizontal distance measurement line 710 (e.g., with a total measured horizontal distance shown here as 99.1 feet), corresponding 3D DSM model data and/or other supplemental 3D information can be obtained and used to calculate a rendered projection of a 3D representation of the measurement line 710 when placed on the ground surface to extend below/beneath a portion of the barn 704 floor area that is enclosed by the barn walls and roof Based on calculating one or more intersections between the 3D representation of the measurement line 710, and the respective surfaces of the 3D object corresponding in the 3D DSM model to the barn 704, the oblique image viewer system 300/oblique view engine 350 of FIG. 3 can determine a first unobstructed portion 722 of the measurement line 710 is not obstructed by the barn 704 in the current oblique viewpoint of oblique image 700; that an obstructed portion 727 of the measurement line 710 is obstructed from view by the barn 704 in the current oblique viewpoint of the oblique image 700; and that a second unobstructed portion 724 of the measurement line 710 is not obstructed by the barn 704 in the current oblique viewpoint of oblique image 700.

In some aspects, the rendered 2D oblique perspective view of the 3D representation of the measurement line 710 can be automatically generated to include only the first unobstructed portion 722 and the second unobstructed portion 724, with the obstructed portion 727 not included such that the rendered 2D oblique perspective view when overlaid on the oblique image 700 provides the appearance of the measurement line 710 being embedded within or physically included within (e.g., interacting with) the objects and elements of the imaged scene, including the barn 704, etc. In some aspects, the obstructed portion 727 is identified as the segment of the measurement line 710 that is between a first intersection point between the measurement line 710 and the left wall of the barn 704, and a second intersection point between the measurement line 710 and the right wall of the barn 704. In some aspects, clipping of obstructed portions of measurement lines and other annotation features may be implemented by the 3D model rendering engine used for generating the 3D-to-2D projected view corresponding to the current oblique viewpoint of the oblique image viewer system 300 of FIG. 3, etc.

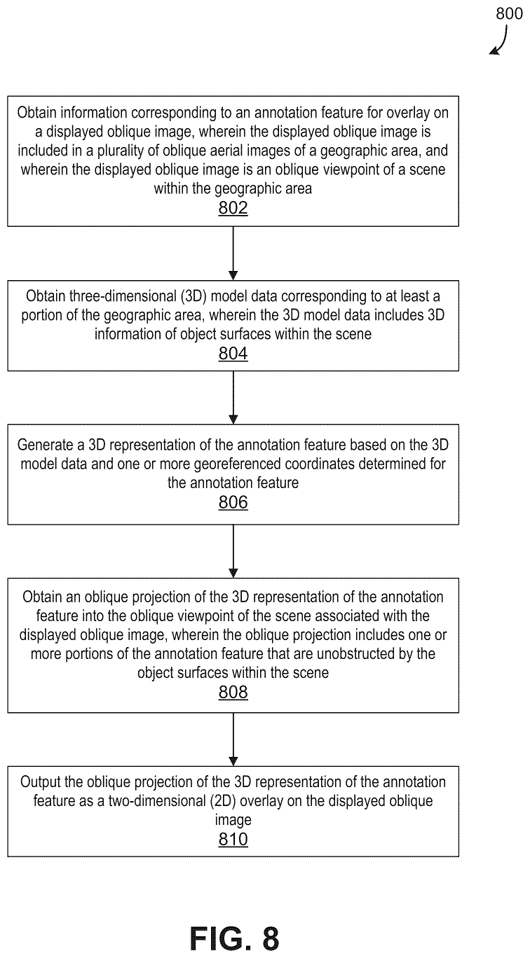

FIG. 8 is a flowchart diagram illustrating an example of a process 800 for the visualization and/or manipulation of non-composite oblique aerial imagery corresponding to a geographic scene or area of interest. In one illustrative example, the process 800 can be implemented by an oblique imagery viewer system, such as the oblique imagery viewer system 300 of FIG. 3, etc. In some aspects, at block 802, the process 800 can include obtaining information corresponding to an annotation feature for overlay on a displayed oblique image (e.g., a currently displayed oblique image being output and/or rendered for display or other presentation to a user), wherein the displayed oblique image is included in a plurality of oblique aerial images of a geographic area (e.g., a geographic area of interest), and wherein the displayed oblique image is an oblique viewpoint of a scene within the geographic area. At block 804, the process 800 can include obtaining three-dimensional (3D) model data corresponding to at least a portion of the geographic area, wherein the 3D model data includes 3D information of object surfaces within the scene. At block 806, the process 800 can include generating a 3D representation of the annotation feature based on the 3D model data and one or more georeferenced coordinates determined for the annotation feature. At block 808, the process 800 can include obtaining an oblique projection of the 3D representation of the annotation feature into the oblique viewpoint of the scene associated with the displayed oblique image, wherein the oblique projection includes one or more portions of the annotation feature that are unobstructed by the object surfaces within the scene. At block 810, the process 800 can include outputting the oblique projection of the 3D representation of the annotation feature as a two-dimensional (2D) overlay on the currently displayed oblique image.

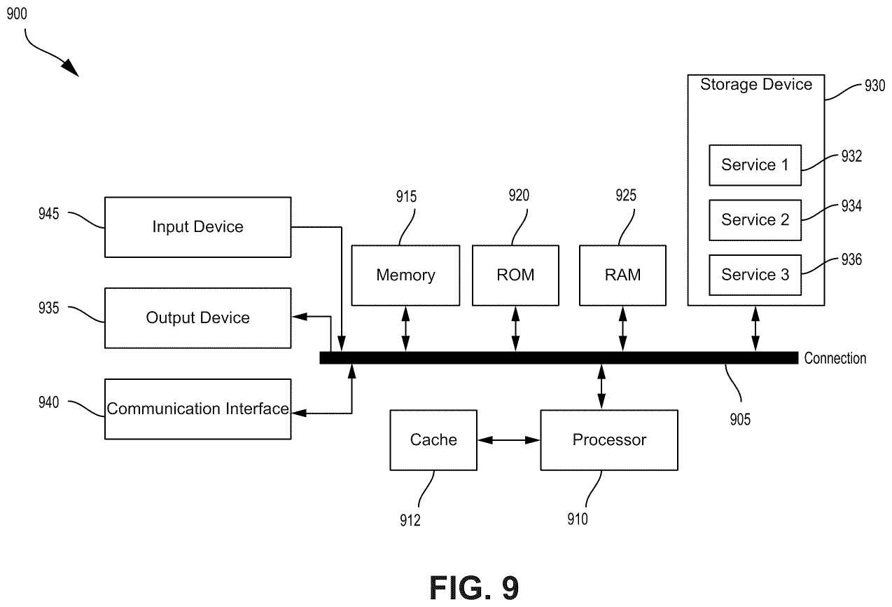

The operations of the process 800 may be implemented as software components that are executed and run on one or more processors (e.g., processor 910 of FIG. 9 or other processor(s)). In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 800 is illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 800 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900, which may be for example any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some aspects, computing system 900 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 may include a cache 915 of high-speed memory connected directly with, in close proximity to, or integrated as part of processor 910.

Processor 910 may include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which maybe one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device (e.g., such as one or more computer-readable storage media) and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof. In some cases, the one or more computer-readable storage media may additionally, or alternatively, correspond to any type of disc, smart card, storage drive(s) (including portable drives, shared drives, network drives, etc.), network shared points, cloud and/or networked storage systems, platforms, services, etc.

The storage device 930 may include software services, servers, services, etc., that when the code that defines such software is executed by the processor 910, it causes the system to perform a function. In some aspects, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“<”) and greater than or equal to (“>”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

What is claimed is:

1. A method comprising:
obtaining information corresponding to an annotation feature for overlay on a displayed oblique image, wherein the displayed oblique image is included in a plurality of oblique aerial images of a geographic area, and wherein the displayed oblique image is an oblique viewpoint of a scene within the geographic area;
obtaining three-dimensional (3D) model data corresponding to at least a portion of the geographic area, wherein the 3D model data includes 3D information of object surfaces within the scene;
generating a 3D representation of the annotation feature based on the 3D model data and one or more georeferenced coordinates determined for the annotation feature;
obtaining an oblique projection of the 3D representation of the annotation feature into the oblique viewpoint of the scene associated with the displayed oblique image, wherein the oblique projection includes one or more portions of the annotation feature that are unobstructed by the object surfaces within the scene; and
outputting the oblique projection of the 3D representation of the annotation feature as a two-dimensional (2D) overlay on the displayed oblique image.

2. The method of claim 1, further comprising:
obtaining a user input indicative of an updated oblique viewpoint of the scene, wherein the updated oblique viewpoint corresponds to a second oblique image different from the displayed oblique image; and
generating an updated oblique projection of the 3D representation of the annotation feature for the updated oblique viewpoint of the scene.

3. The method of claim 2, further comprising:
outputting the second oblique image and the updated oblique projection of the 3D representation of the annotation feature as a 2D overlay on the second oblique image.

4. The method of claim 2, wherein generating the updated oblique projection comprises reprojecting the 3D representation of the annotation feature from a 3D space of the 3D model data to a 2D oblique space corresponding to the updated oblique viewpoint of the scene.

5. The method of claim 1, wherein the oblique viewpoint of the scene is based on an image frame center coordinate of the displayed oblique image and a georeferenced boundary information associated with one or more of the displayed oblique image or the scene within the geographic area.

6. The method of claim 1, wherein the oblique viewpoint of the scene is based on an orientation angle or heading information of the displayed oblique image.

7. The method of claim 1, wherein the one or more portions of the annotation feature that are unobstructed by the object surfaces are determined based on intersecting the 3D representation of the annotation feature with the 3D information of the object surfaces within the scene.

8. The method of claim 7, wherein the one or more portions of the annotation feature that are unobstructed by the object surfaces are further determined based on parameterizing a 3D to 2D projection of the 3D representation of the annotation feature based on orientation angle or heading information included in the oblique viewpoint of the scene.

9. The method of claim 1, wherein the oblique projection does not include one or more portions of the annotation feature that are obstructed by the object surfaces within the scene.

10. The method of claim 1, wherein the 3D representation of the annotation feature is generated in a same 3D coordinate system as the 3D model data, based on transforming the one or more georeferenced coordinates to the 3D coordinate system.

11. The method of claim 1, wherein the oblique projection comprises a 3D-to-2D projection.

12. The method of claim 1, wherein the 3D model data comprises Digital Surface Model (DSM) 3D data corresponding to one or more objects or elements included within the scene within the geographic area.

13. The method of claim 1, wherein the 3D model data includes supplemental 3D information indicative of one or more surfaces and corresponding georeferenced coordinates of one or more objects or elements included within the scene within the geographic area.

14. The method of claim 1, wherein the annotation feature comprises at least one of an annotation point, a line, a polyline, text data, a polygon, or an enclosed area within the scene.

15. A system comprising:
one or more processors; and
one or more computer-readable storage media having computer-readable instructions stored thereon, wherein the computer-readable instructions, when executed by the one or more processors, cause the one or more processors to:
obtain information corresponding to an annotation feature for overlay on a displayed oblique image, wherein the displayed oblique image is included in a plurality of oblique aerial images of a geographic area, and wherein the displayed oblique image is an oblique viewpoint of a scene within the geographic area;
obtain three-dimensional (3D) model data corresponding to at least a portion of the geographic area, wherein the 3D model data includes 3D information of object surfaces within the scene;
generate a 3D representation of the annotation feature based on the 3D model data and one or more georeferenced coordinates determined for the annotation feature;
obtain an oblique projection of the 3D representation of the annotation feature into the oblique viewpoint of the scene associated with the displayed oblique image, wherein the oblique projection includes one or more portions of the annotation feature that are unobstructed by the object surfaces within the scene; and
output the oblique projection of the 3D representation of the annotation feature as a two-dimensional (2D) overlay on the displayed oblique image.
